(19) United States
(12) Patent Application Publication
(10) Pub. No.: US 2018/0029156 A1
(43) Pub. Date: Feb. 1, 2018

(54) Discharge Welding System

(71) Applicant: Electric Power Systems, LLC, Chandler, AZ (US)

(72) Inventors: Randy B. Dunn, Orange, CA (US); James R. Banwell, Claremont, CA (US)

(73) Assignee: Electric Power Systems, LLC

(21) Appl. No.: 15/664,037

(22) Filed: Jul. 31, 2017

Related U.S. Application Data
(60) Provisional application No. 62/368,425, filed on Jul. 29, 2016.

(51) Int. Cl. B23K 11/26; B23K 11/31

(52) U.S. Cl. CPC B23K 11/26; B23K 11/312; B23K 2201/36

(57) ABSTRACT

A discharge welding system for discharge welding a welding member such as a stud to a weld surface such as a battery terminal or strap. The discharge welding system generally includes a power source which is electrically connected to both a clamp and a retainer such as a collet. The clamp is utilized to secure a conduction member such as a washer against a weld surface such as a battery terminal or strap. The retainer is utilized to removably retain a welding member such as a stud which is adapted to be welded to the weld surface. A weld actuator is adapted to lower the retainer such that the welding member contacts the conduction member to complete an electrical circuit as an electrical current is discharged by the power source. The welding member is welded to the weld surface by the electrical current discharge.

### CROSS REFERENCE TO RELATED APPLICATIONS

I hereby claim benefit under Title 35, United States Code, Section 119(e) of U.S. provisional patent application Ser. No. 62/368,425 filed Jul. 29, 2016. The 62/368,425 application is currently pending. The 62/368,425 application is hereby incorporated by reference into this application.

### STATEMENT REGARDING FEDERALLY SPONSORED RESEARCH OR DEVELOPMENT

Not applicable to this application.

### BACKGROUND

### Field

Example embodiments in general relate to a discharge welding system for discharge welding a welding member such as a stud to a weld surface such as a battery terminal or strap.

### Related Art

Any discussion of the related art throughout the specification should in no way be considered as an admission that such related art is widely known or forms part of common general knowledge in the field.

A secondary battery is a device consisting of one or more electrochemical or electrostatic cells, hereafter referred to collectively as “cells”, that can be charged electrically to provide a static potential for power or released electrical charge when needed. The cell is basically comprised of at lease one positive electrode and at least one negative electrode. One common form of such a cell is the well-known secondary cell packaged in a cylindrical metal can or in a prismatic case. Examples of chemistry used in such secondary cells are lithium cobalt oxide, lithium manganese, lithium iron phosphate, nickel cadmium, nickel zinc, and nickel metal hydride. Other types of cells include capacitors, which can come in the form of electrolytic, tantalum, ceramic, magnetic, and include the family of super and ultra capacitors. Such cells are mass produced, driven by an ever-increasing consumer market that demands low cost rechargeable energy for portable electronics. Energy density is a measure of a cell's total available energy with respect to the cell's mass, usually measured in Watt-hours per kilogram, or Wh/kg. Power density is a measure of the cell's power delivery with respect to the cell's mass, usually measured in Watts per kilogram, or W/kg.

In order to attain the desired operating voltage level, cells are electrically connected in series to form a battery of cells, what is typically referred to as a battery. In order to attain the desired current level, cells are electrically connected in parallel. When cells are assembled into a battery, the cells are often linked together through metal strips, straps, wires, bus bars, etc., that are welded, soldered, or otherwise fastened to each cell to link them together in the desired configuration.

Secondary batteries are often used to drive traction motors in order to propel electric vehicles. Such vehicles include electric bikes, motorcycles, cars, busses, trucks, trains, and so forth. Such traction batteries are usually large format types, comprised of tens to hundreds or more individual cells. The cells are linked together internally and installed into a case to form the completed battery.

A common method of electrical connection to the cells is welding. Several techniques are well known in the industry, including resistance spot welding, and laser welding. For some cells that have aluminum terminals, only laser welding is known to work to allow a proper connection to the terminal. Examples of such cells are lithium titanate cells manufactured by Toshiba Corporation and sold under the trade name SCiB. Unfortunately laser welders are costly, usually $500,000 to several million dollars each. Conventional more cost effective resistance type spot welding techniques cannot form a proper bond to the aluminum terminals.

The mechanical fabrication industry uses a technique known as capacitive discharge stud welding. Stud welding is a technique of welding where a fastener or specially formed nut is welded onto another metal part, typically a base metal or substrate. The fastener can take different forms, but typically fall under threaded, unthreaded or tapped. The bolts may be automatically fed into a spot welder achieving high speed assembly. Weld nuts generally have a flange with small nubs that melt to form the weld.

Capacitor Discharge (CD) stud welding, using very short weld times, permits the welding of small-diameter studs to thin, lightweight materials. The weld cycle can be completed in 0.01 seconds on material as thin as 0.020″ (0.5 mm). These fast weld times minimize heat buildup, resulting in welds with very little distortion, discoloration, or burning.

In Gap CD stud welding, the stud is positioned above, not against, the workpiece. When the stud is released, it accelerates toward the workpiece. Simultaneously, an open-circuit voltage is applied to the gap. The ignition tip is vaporized and the pieces are melted and forced together to form the weld.

### SUMMARY

An example embodiment is directed to a discharge welding system. The discharge welding system includes a power source which is electrically connected to both a clamp and a retainer such as a collet. The clamp is utilized to secure a conduction member such as a washer against a weld surface such as a battery terminal or strap. The retainer is utilized to removably retain a welding member such as a stud which is adapted to be welded to the weld surface. A weld actuator is adapted to lower the retainer such that the welding member contacts the conduction member to complete an electrical circuit as an electrical current is discharged by the power source. The welding member is welded to the weld surface by the electrical current discharge.

There has thus been outlined, rather broadly, some of the embodiments of the discharge welding system in order that the detailed description thereof may be better understood, and in order that the present contribution to the art may be better appreciated. There are additional embodiments of the discharge welding system that will be described hereinafter and that will form the subject matter of the claims appended hereto. In this respect, before explaining at least one embodiment of the discharge welding system in detail, it is to be understood that the discharge welding system is not limited in its application to the details of construction or to the arrangements of the components set forth in the following description or illustrated in the drawings. The discharge welding system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is an exploded perspective view of a discharge welding system in accordance with an example embodiment.

FIG. 2 is a side view of a discharge welding system in accordance with an example embodiment.

FIG. 3 is a side view of a discharge welding system with a battery in position in accordance with an example embodiment.

FIG. 4 is a side sectional view of a discharge welding system with a battery in position in accordance with an example embodiment.

FIG. 5 is a side sectional view of a discharge welding system with a battery in position and a conduction member clamped to the battery in accordance with an example embodiment.

FIG. 6 is a side sectional view of a discharge welding system lowering the weld actuator to weld a stud to a weld surface in accordance with an example embodiment.

FIG. 7 is a side sectional view of a discharge welding system after welding the stud to the weld surface with the weld actuator retracted accordance with an example embodiment.

FIG. 8 is a side sectional view of a discharge welding system welding a battery strap in accordance with an example embodiment.

FIG. 9a is a side sectional view of a discharge welding system prior to use in accordance with an example embodiment.

FIG. 9b is a side sectional view of a discharge welding system with the conduction member clamped to the weld surface in accordance with an example embodiment.

FIG. 9c is a side sectional view of a discharge welding system as the stud is being welded to the weld surface in accordance with an example embodiment.

FIG. 9d is a side sectional view of a discharge welding system after the stud has been welded to the weld surface in accordance with an example embodiment.

FIG. 10 is an exemplary block diagram of a discharge welding system in accordance with an example embodiment.

FIG. 11 is a flowchart illustrating electrically connecting the clamp and retainer to a power source in accordance with an example embodiment.

FIG. 12 is a flowchart illustrating preparation of object for welding in accordance with an example embodiment.

FIG. 13 is a flowchart illustrating an exemplary welding process in accordance with an example embodiment.

FIG. 14 is a flowchart illustrating removal of the object after welding has been completed in accordance with an example embodiment.

### DETAILED DESCRIPTION

### A. Overview

An example discharge welding system generally comprises a power source 50 which is electrically connected to both a clamp 35 and a retainer 45 such as a collet. The clamp 35 is utilized to secure a conduction member 37 such as a washer against a weld surface 16 such as a battery terminal 13 or strap 14. The retainer 45 is utilized to removably retain a welding member 48 such as a stud which is adapted to be welded to the weld surface 16. A weld actuator 40 is adapted to lower the retainer 45 such that the welding member 48 contacts the conduction member 37 to complete an electrical circuit as an electrical current is discharged by the power source 50. The welding member 48 is welded to the weld surface 16 by the electrical current discharge. Using such a configuration, the weld surface 16 itself need not be electrically connected to the power source 50. This is useful where the weld surface 16 comprises an electrically isolated structure, such as a battery terminal 13.

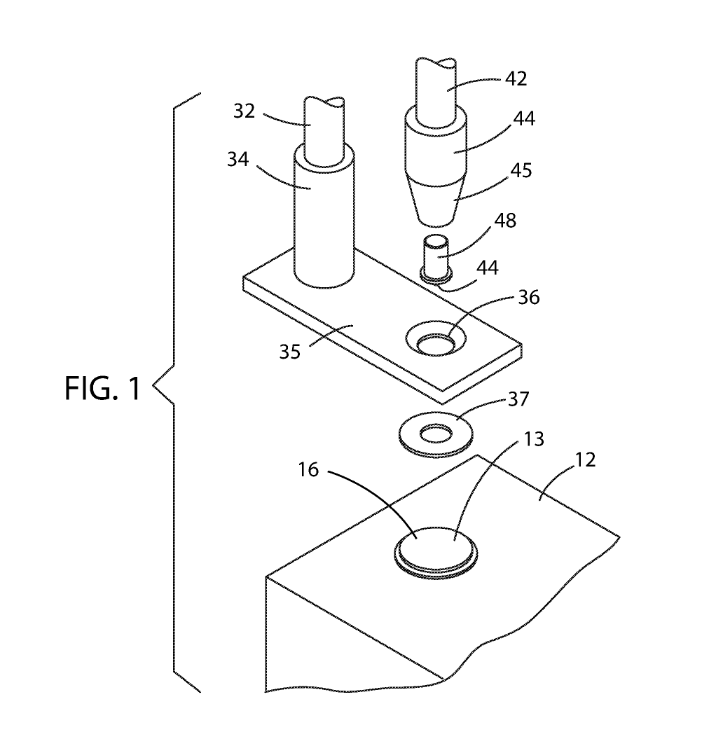

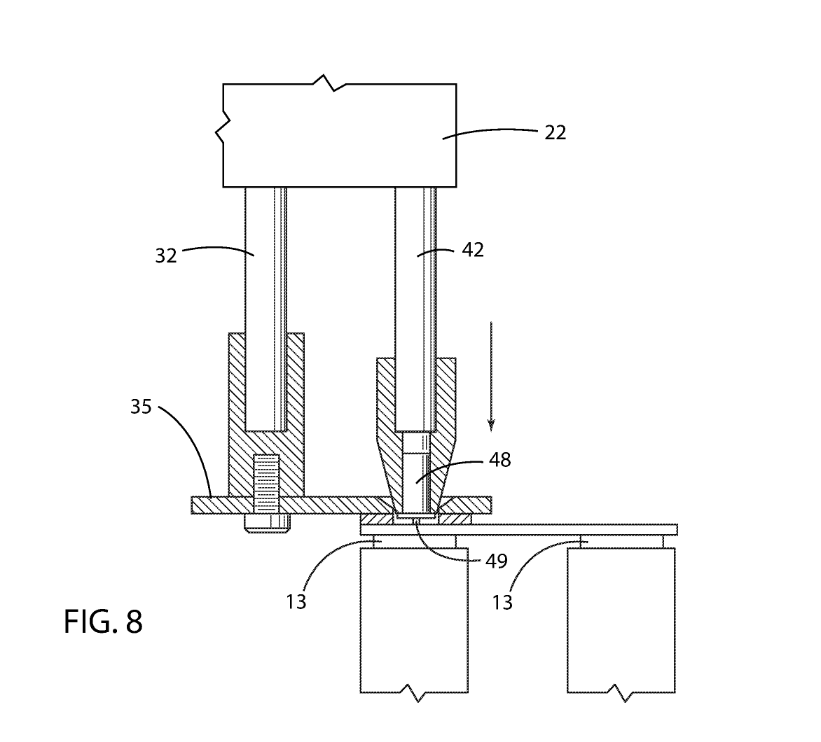

The methods and systems described herein may be utilized with a wide range of weld surface 16 and welding members 48 to provide a wide range of functionalities. The methods and systems disclosed herein are particularly well-suited for applications relating to batteries. For example, the weld surface 16 could comprise a battery terminal 13 as shown in FIGS. 1-7 or a battery strap 14 which interconnects cells as shown in FIG. 8. The methods and systems described herein could be utilized to weld any high current conductors with any different types of materials. The welding members 48 may comprise studs, blocks, plates, or the like. The methods and systems described herein could be utilized to weld aluminum battery straps 14 with metal studs as shown in FIG. 8.

The welding system 10 may comprise a conduction member 37 adapted to contact a weld surface 16 and a welding member 48 adapted to be welded to the weld surface 16. A clamp 35 is adapted to transfer an electrical current from a power source 50 to the conduction member 37; with the clamp 35 being electrically connected to the power source 50. A retainer 45 adapted to transfer electrical current from the power source 50 to the welding member 48 is electrically connected to the power source 50. The retainer 50 is adapted to removably retain the welding member 48 to be welded to the weld surface 16. A weld actuator 40 may be provided to lower the welding member 48 to contact the conduction member 37 to weld the welding member 48 onto the weld surface 16 when the welding member 48 contacts the conduction member 37. The weld surface 16 may comprise a battery terminal and the welding member 48 may comprise a stud. The conduction member 37 may comprise a washer. In some embodiments, the clamp 35 may comprise an anode connection and the retainer 48 may comprise a cathode connection. The retainer 45 may comprise a collet. A housing 20 may be positioned over the weld surface 16. The clamp 35 may comprise a rectangular plate. The clamp 35 may also include an opening 36; with the welding member 38 being adapted to be driven through the opening 36 by the weld actuator 40.

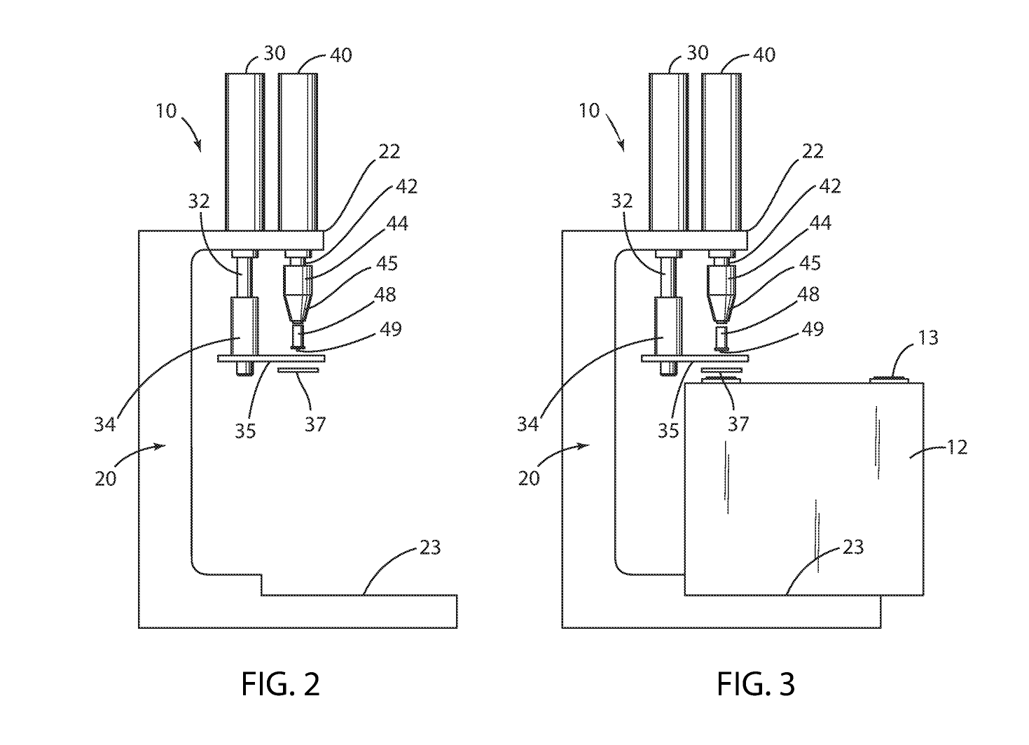

In an exemplary embodiment as shown in FIGS. 2-7, the discharge welding system 10 may comprise a housing 20 adapted to be positioned over a weld surface 16, a conduction member 37 adapted to be positioned on the weld surface 16, and a welding member 48 adapted to be welded to the weld surface 16. A power source 50 is utilized to provide an electrical current. A clamp 35 adapted to transfer the electrical current from the power source 50 to the conduction member 37 is electrically connected to the power source 50. A retainer 45 adapted to transfer electrical current from the power source 50 to the welding member 48 is adapted to removably retain the welding member 48 to be welded to the weld surface 16. A weld actuator 40 connected to the housing 20 is adapted to lower the welding member 48 to contact the conduction member 37, wherein the welding member 48 is adapted to be welded onto the weld surface 16 when the welding member 48 contacts the conduction member 37. A clamp actuator 30 connected to the housing 20 is adapted to raise and lower the clamp 35, wherein the clamp actuator 30 is adapted to lower the clamp 35 to retain the conduction member 37 against the weld surface 16.

A method of discharge welding is disclosed, comprising the steps of electrically connecting a clamp 35 to a power source 50, electrically connecting a retainer 45 to the power source 50, securing a conduction member 37 against a weld surface 16 with the clamp 35, removably securing a welding member 48 with the retainer 45, adjusting the welding member 48 such that the welding member 48 contacts the conduction member 37, and activating the power source 50 to direct an electrical current through the retainer 45, the welding member 48, the clamp 35, and the conduction member 37 such that the welding member 48 is welded to the weld surface 16 by an electrical discharge.

### B. Housing

As shown throughout the figures, a housing 20 may be utilized to position the actuators 30, 40 over the object 12; with the weld actuator 40 preferably being positioned directly above the weld surface 16 of the object 12. In some embodiments such as shown in the figures, the object 12 may itself be removably connected to the housing 20 such that the object 12 will not move around during the welding process. This may improve accuracy and reduce the likelihood of welding errors.

The shape, size, and configuration of the housing 20 may vary in different embodiments. In the exemplary embodiment shown in FIGS. 2-7, the housing 20 may comprise a base 24 and a support 22 extending upwardly over the base 24. The base 24 may be free-standing or may be connected, such as by bolts or the like, to a surface such as a table or work bench. The base 24 may include a depressed portion to receive the object 12 such as shown in FIGS. 2 and 3. The base 24, and housing 20 overall, will preferably be sufficiently sturdy to prevent unwanted vibrations or movements during the welding processes described herein.

The housing 20 may also include a support 22 to which the actuators 30, 40 are connected such that the actuators 30, 40 are positioned over the object 12. The support 22 may comprise various configurations, including different shapes, sizes, orientations, and the like. The support 22 may in some embodiments be height adjustable such that the positioning of the actuators 30, 40 may be adjusted to accommodate differently-sized objects 12.

In an exemplary embodiment as shown in FIGS. 2-7, the support 22 may comprise a horizontal projection which extends over the position of the object 12. The clamp actuator 30 will preferably be positioned at a horizontal offset with respect to the weld surface 16. The weld actuator 40 will preferably be positioned directly above the weld surface 16 such that the welding member 48 may be vertically lowered to contact the weld surface 16 through the clamp 35.

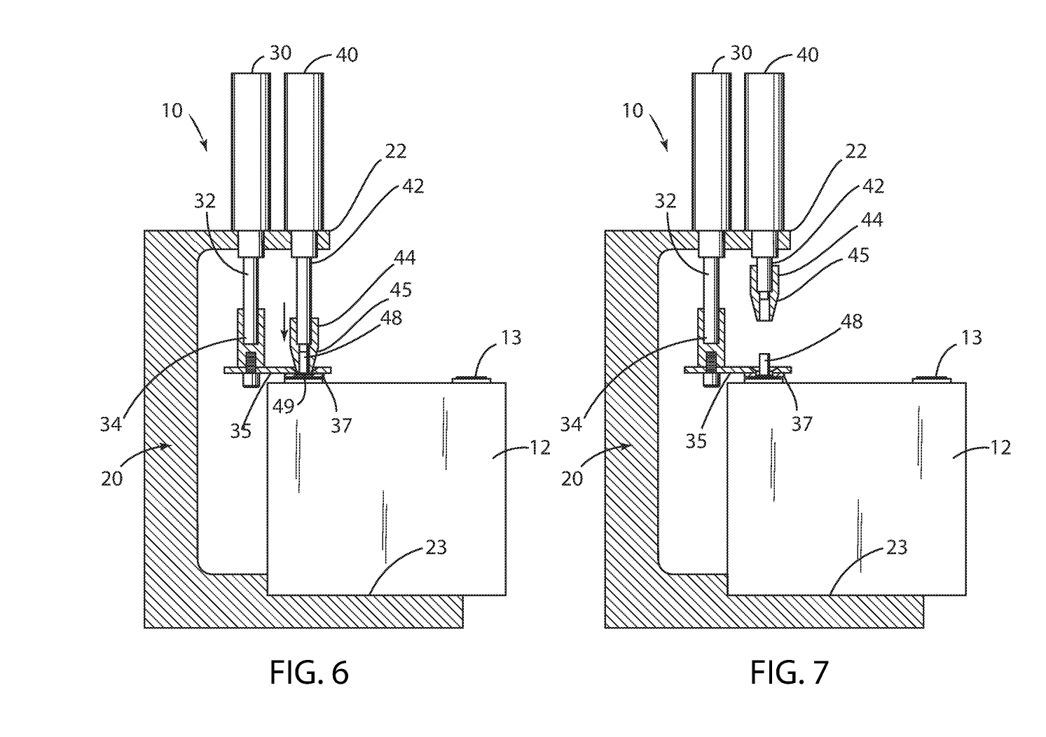

The actuators 30, 40 may be removably connected to the housing 20 in some embodiments. This allows the actuators 30, 40 to be removed for servicing or replacement. The support 22 may include openings through which the actuators 30, 40 extend in some embodiments. Preferably, the actuators 30, 40 are connected to the support 22 of the housing 20 such that their respective shafts 32, 42 extend downwardly from the support 22 such as shown in FIGS. 5 and 6.

### C. Clamp

As shown throughout the figures, a clamp 35 is utilized to temporarily secure a conduction member 37 against the weld surface 16 of the object 12. The clamp 35 may comprise various configurations, shapes, sizes, orientations, and the like. Thus, the configuration shown in the figures should not be construed as limiting on the scope of the present invention.

As best shown in FIG. 1, the clamp 35 may comprise a rectangular plate-like member having an opening 36. It should be appreciated that the clamp 35 need not necessarily comprise a rectangular shape, as other shapes may be more suitable for specific objects 12 or weld surfaces 16. In the figures, the clamp 35 comprises a rectangular plate; with a position near a first end of the clamp 35 being connected to a clamp actuator 30 and a position near a second end of the clamp 35 including the opening 36. Various other configurations may be utilized for different embodiments.

The shape, positioning, size, and orientation of the opening 36 in the clamp 35 may vary in different embodiments to suit different conduction members 37 and/or welding members 48. As best shown in FIG. 1, the opening 36 may comprise a depressed opening 36 having sloped sidewalls. Such an embodiment will naturally drive welding members 48 such as studs toward and through the opening 36.

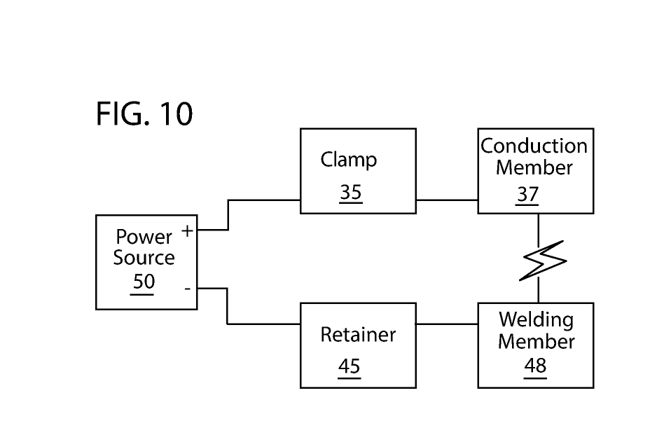

The clamp 35 will preferably be electrically connected to a power source 50 such as shown in FIG. 10. The manner in which the clamp 35 is electrically connected to the power source 50 may vary in different embodiments. In some embodiments, external conduits may be utilized to connect the clamp 35 to the power source 50. In other embodiments, conduits may be internal to the housing 20. In some embodiments, there may be intervening structures, devices, or the like electrically connected between the clamp 35 and the power source 50. While FIG. 10 illustrates the clamp 35 as comprising an anode connection, the reverse may be utilized in some embodiments; with the clamp 35 serving as a cathode connection.

As best shown in FIGS. 5-8, 9b, 9c, and 9d, the clamp 35 is preferably lowered to press the conduction member 37 against the weld surface 16; with the conduction member 37 being sandwiched between the clamp 35 and the weld surface 16. In some embodiments, the clamp 35 may be manually secured against the weld surface 16, such as via a vice grip or the like.

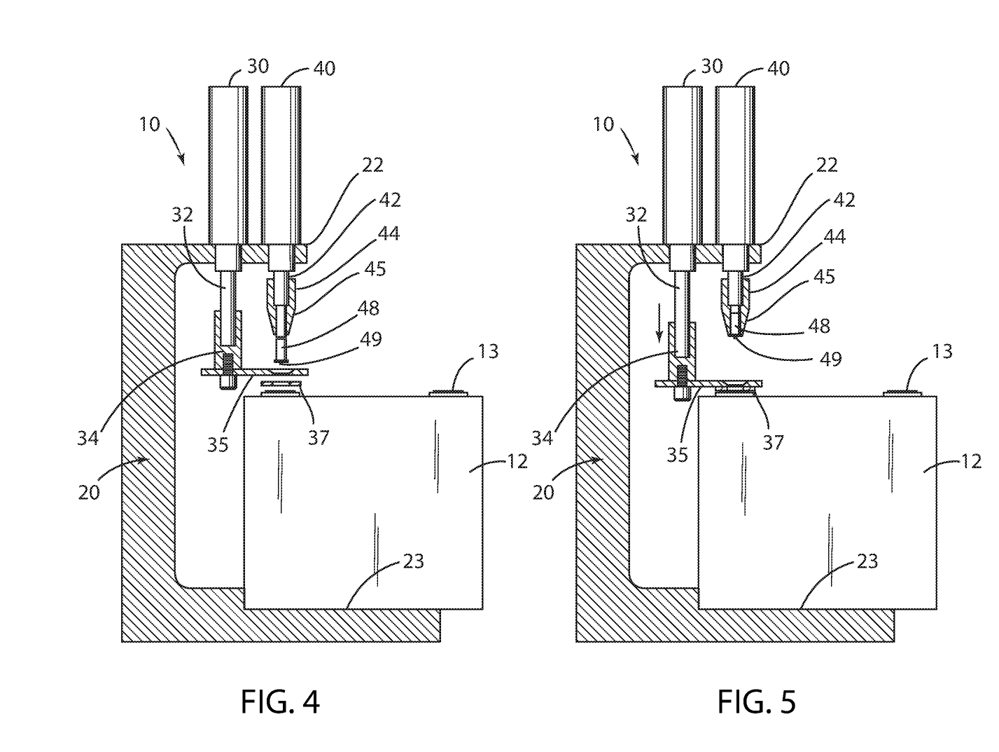

As shown in FIGS. 4 and 5, the clamp 35 is adjustable between a first, raised position above a point near the weld surface 16 and a second, lowered position wherein the clamp 35 is pressed against the weld surface 16 to secure the conduction member 37 against the weld surface 16. In the embodiment shown in FIGS. 2-7, a clamp actuator 30 is utilized to raise and lower the clamp 35.

The clamp actuator 30 may comprise a linear actuator including a first shaft 32 which is adapted to be extended and retracted with respect to the base of the clamp actuator 30. Various other types of weld actuators 30 may be utilized and thus the scope of the present invention should not be construed as limited to linear actuators.

In the embodiment shown in the figures, a first connector 34 is connected between the first shaft 32 and the clamp 35. In some embodiments, the first shaft 32 of the clamp actuator 30 may be directly connected to the clamp 35. The clamp 35 may be removably or fixedly connected to the first shaft 32 or first connector 34. In some embodiments, the power source 50 may be electrically connected to the first connector 34 such that an electrical current flows through the first connector 34 to the clamp 35. In other embodiments, the power source 50 may be electrically connected directly to the clamp 35.

As shown in FIGS. 5-7, the clamp 35 may secure a conduction member 37 against a weld surface 16. The conduction member 37 is adapted to facilitate conduction of current to the weld surface 16 during the weld process. The conduction member 37 may comprise various conductive materials such as metals. Electrical current will generally flow from the power source 50 through the clamp 35 to the conduction member 37 when welding. However, in some embodiments, the power source 50 may be directly connected to the conduction member 37.

The shape, size, and configuration of the conduction member 37 may vary in different embodiments. In the figures, the conduction member 37 is illustrated as comprising a washer, such as a brass washer. In some embodiments, the conduction member 37 may be disposable as the conduction member 37 may be damaged during welding.

While the figures illustrate the conduction member 37 as being circular-shaped, it could comprise other shapes such as rectangular plates and the like. The conduction member 37 is generally pressed with force against the weld surface 16 by the clamp 35. The conduction member 37 will generally include an opening to allow the welding member 48 to contact both the conduction member 37 and the weld surface 16.

### D. Weld Actuator

As shown throughout the figures, a retainer 45 may be utilized to removably retain the welding member 48 during portions of the welding methods described herein. The retainer 45 may comprise any device or structure adapted to removably secure the welding member 48 therein. The retainer 45 may comprise various configurations, shapes, sizes, orientations, and the like. Thus, the configuration shown in the figures should not be construed as limiting on the scope of the present invention.

As best shown in FIG. 1, the retainer 45 may in some embodiments comprise a collet. In other embodiments, the retainer 45 could comprise various clamps, brackets, or the like adapted to removably secure the welding member 48. The retainer 45 will generally secure the welding member 48 until the welding member 48 has been welded to the weld surface 16 as described herein. The retainer 45 may vary in different embodiments to suit different types of welding members 48.

The retainer 45 will preferably be electrically connected to the power source 50 such as shown in FIG. 10. The manner in which the retainer 45 is electrically connected to the power source 50 may vary in different embodiments. In some embodiments, external conduits may be utilized to connect the retainer 45 to the power source 50. In other embodiments, conduits may be internal to the housing 20. In some embodiments, there may be intervening structures, devices, or the like electrically connected between the clamp 35 and the power source 50. While FIG. 10 illustrates the retainer 45 as comprising a cathode connection, the reverse may be utilized in some embodiments; with the retainer 45 serving as a cathode connection.

As best shown in FIGS. 6, 8, and 9c, the retainer 45 is preferably lowered such that the welding member 48 therein contacts the conduction member 37 to weld the welding member 48 to the weld surface 16. In some embodiments, the clamp 35 may be manually lowered to contact the conduction member 37, such as via a vice grip, by hand, or the like.

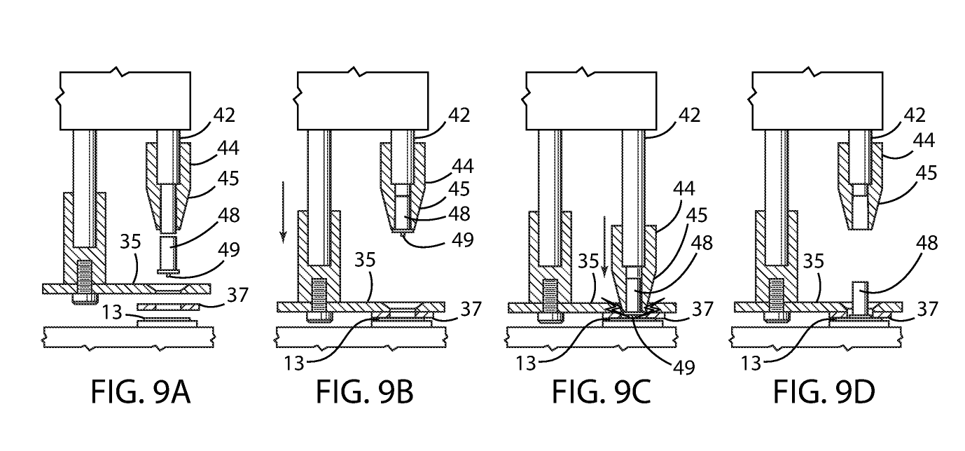

As shown in FIGS. 9b and 9c, the retainer 45 is adjustable between a first, raised position above conduction member 37 and the weld surface 16 and a second, lowered position wherein the welding member 48 within the retainer 45 contacts the conduction member 37 to weld the welding member 48 against the weld surface 16. In the embodiment shown in FIG. 6, a weld actuator 40 is utilized to raise and lower the retainer 45.

The weld actuator 40 may comprise a linear actuator including a second shaft 42 which is adapted to be extended and retracted with respect to the base of the weld actuator 40. Various other types of weld actuators 40 may be utilized and thus the scope of the present invention should not be construed as limited to linear actuators.

In the embodiment shown in the figures, a second connector 44 is connected between the second shaft 42 and the retainer 45. In some embodiments, the second shaft 42 of the weld actuator 40 may be directly connected to the retainer 45. The retainer 45 may be removably or fixedly connected to the second shaft 42 or second connector 44. In some embodiments, the power source 50 may be electrically connected to the second connector 44 such that an electrical current flows through the second connector 44 to the retainer 45. In other embodiments, the power source 50 may be electrically connected directly to the retainer 45.

As best shown in FIG. 5, a welding member 48 is removably secured to the retainer 45. The welding member 48 is adapted to be discharge welded to the weld surface 16 upon contacting the conduction member 37, such as by being lowered by the weld actuator 40. The welding member 48 may comprise various conductive materials such as metals. Electrical current will generally flow from the power source 50 through the retainer 45 to the welding member 48 when welding. However, in some embodiments, the power source 50 may be directly connected to the welding member 48.

The shape, size, and configuration of the welding member 48 may vary in different embodiments. In the figures, the welding member 48 is illustrated as comprising a stud. In other embodiments, the welding member 48 could comprise a plate, a block with an opening in it, a nut, or any other medium known to be suitable for welding to a weld surface 16.

The welding member 48 may include a tip 49 as best shown in FIG. 8. When the power source 50 is discharged, the tip 49 will be vaporized and an arc will be formed. This arc melts the welding member 48 against the weld surface 16 such as shown in FIG. 9c. The shape, size, configuration, and orientation of the tip 49 of the welding member 48 may vary in different embodiments. Any tip 49 known in the art to be useful for discharge welding may be utilized.

### E. Operation of Preferred Embodiment

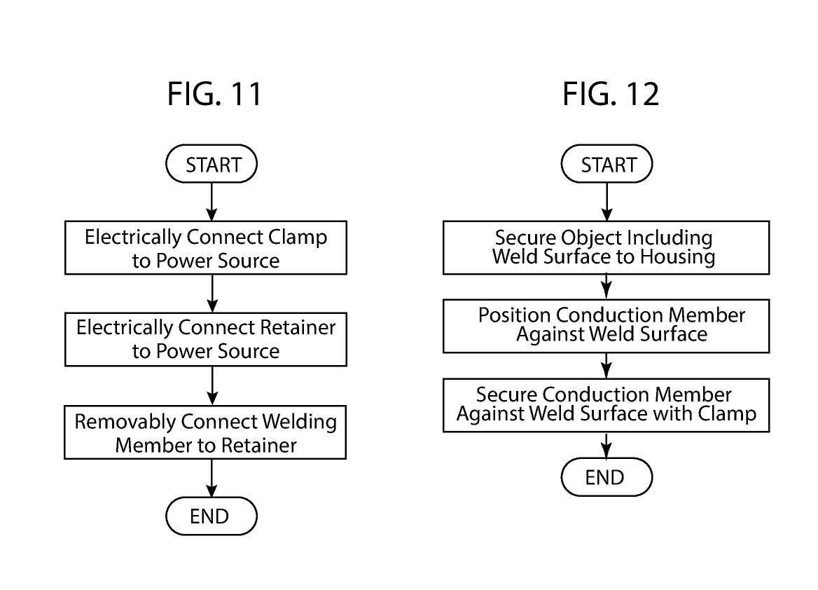

In use, the power source 50 may first be electrically connected so as to provide a current through the conduction member 37 and the welding member 48. As shown in FIG. 11, an exemplary embodiment electrically connects the clamp 35 and the retainer to the power source 50. The welding member 48 may be removably connected to the retainer 45 either before or after the power source 50 is electrically connected to the conduction member 37 and/or welding member 48.

It should be appreciated that a wide range of power sources 50 may be utilized to provide an electrical current. Any power source 50 known in the art to generate an electrical current may be utilized. In an exemplary embodiment, the power source 50 may comprise a capacitor. The power source 50 may comprise a welding machine in some embodiments.

The manner in which the power source 50 is electrically connected to the clamp 35 and the retainer 45 may vary in different embodiments. The power source 50 may be electrically connected with the first connector 34 which itself is electrically connected with the clamp 35. The power source 50 may be electrically connected with the second connector 44 which itself is electrically connected with the retainer 45. Alternatively, the power source 50 could be directly electrically connected with the clamp 35 and retainer 45.

An exemplary embodiment is illustrated in FIG. 10 in which the positive connection of the power source 50 is electrically connected to the clamp 35 and the negative connection of the power source 50 is electrically connected to the retainer 45. Other configurations may be utilized as this is merely an exemplary embodiment.

As shown in FIG. 12, an object 12 such as a battery may be secured to the housing 20. In embodiments where the object 12 is not secured to the housing 20, the object 12 may be positioned on a flat surface so that that inadvertent movement is minimized. The object 12 may be secured against a base 24 of a housing 20 as shown in FIGS. 3-7. Clamps, vices, brackets, or the like may be utilized to removably connect the object 12 to the base 24 of the housing 20. In some embodiments, the base 24 will comprise a depressed portion in which the object 12 may sit without moving. This type of embodiment is useful where a specific sized object 12 is being utilized, such as a standard battery size.

The conduction member 37 is secured against the weld surface 16 on the object 12. The conduction member 37 may be secured against the weld surface 16 by the clamp 35 as shown in FIGS. 9b, 9c, and 9d. In an exemplary embodiment, the clamp actuator 30 may be activated so as to extend the first shaft 32 and lower the clamp 35 onto the conduction member 37 so as to secure the conduction member 37 against the weld surface 16.

The welding member 48 may be removably secured to the retainer 45. In the exemplary embodiment shown in FIG. 5, the welding member 48 comprises a stud which is removably secured within a retainer 45 comprising a collet. Various other configurations may be utilized for removably connecting the retainer 45 and the welding member 48. The tip 49 of the welding member 48 will preferably extend downwardly from the retainer 45 so as to be able to contact the weld surface 16 through the clamp 35 and conduction member 37 when the welding member 48 is lowered.

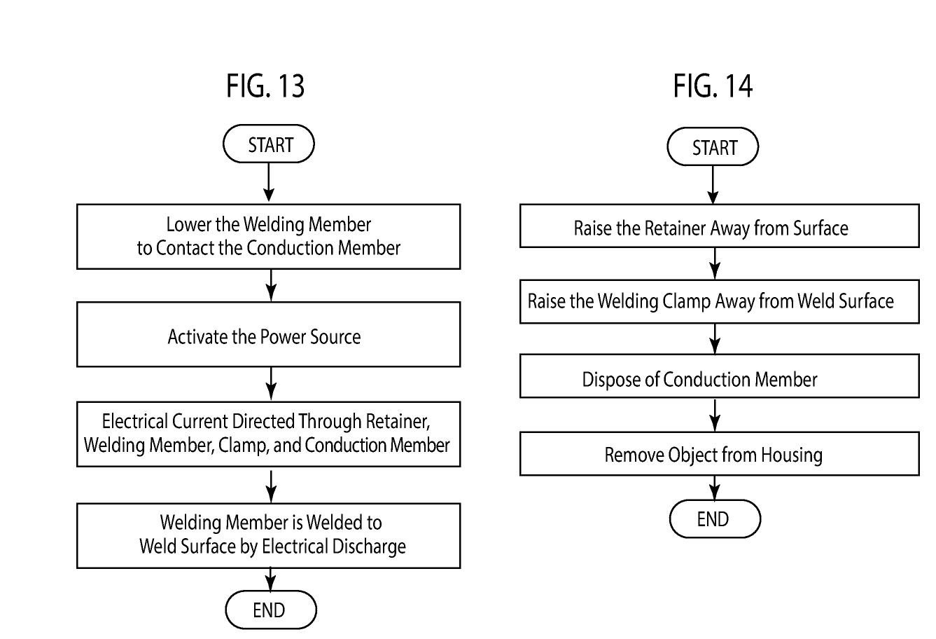

As shown in FIG. 13, the welding member 48 is then adjusted, such as by lowering, to contact the conduction member 37. The welding member 48 may be adjusted by a weld actuator 40 as shown in FIGS. 6 and 9c. The weld actuator 40 may be activated to extend the second shaft 42 and retainer 45 such that the welding member 48 within the retainer 45 contacts the clamp 35.

As the welding member 48 nears the clamp 35, the power source 50 may be activated to produce an electrical current directed through the retainer 45, clamp 35, welding member 48, and conduction member 37 such as shown in FIG. 10. In some embodiments, the power source 50 may be activated prior to lowering the welding member 48.

The welding member 48 is directed through the opening 36 of the clamp 35 to contact the conduction member 37; completing the electrical circuit. The tip 49 of the welding member 48 will be vaporized such that the welding member 48 melts against the weld surface 16.

The electrical current will generally pass through the clamp 35 to the conduction member 37. When the retainer 45 is lowered with the welding member 48 such that the welding member 48 contacts the conduction member 37, an electrical circuit is completed and the electrical current will pass through the welding member 48 and retainer 45; arcing to dissolve the tip 49 of the welding member 48 and thus weld the welding member 48 to the weld surface 16.

FIGS. 9a-9d illustrate such a method being utilized to weld a welding member 48 comprised of a stud to a weld surface 16 comprised of a terminal 13 of an object 12 comprised of a battery. FIG. 8 illustrates such a method being utilized to weld a welding member 48 comprised of a stud to a weld surface 16 comprising a strap 14 of an object 12 comprised of a battery. These are merely exemplary embodiments and should not be construed as limiting on the type of object 12 or weld surface 16.

As shown in FIG. 14, after the weld is complete, the retainer 45 may then be raised away from the weld surface 16, such as by activating the weld actuator 40 to retract the second shaft 42. The weld member 48 will remain welded to the weld surface 16. The clamp 35 may be raised from the weld surface 16. The conduction member 37 will typically be damaged and may be disposed of. The object 12 may then be removed from the housing 20 or repositioned for further welds.

Unless otherwise defined, all technical and scientific terms used herein have the same meaning as commonly understood by one of ordinary skill in the art to which this invention belongs. Although methods and materials similar to or equivalent to those described herein can be used in the practice or testing of the discharge welding system, suitable methods and materials are described above. All publications, patent applications, patents, and other references mentioned herein are incorporated by reference in their entirety to the extent allowed by applicable law and regulations. The discharge welding system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A welding system, comprising:
a conduction member adapted to contact a weld surface;
a welding member adapted to be welded to the weld surface;
a power source for providing an electrical current;
a clamp adapted to transfer the electrical current from the power source to the conduction member, wherein the clamp is electrically connected to the power source;
a retainer adapted to transfer electrical current from the power source to the welding member, wherein the retainer is electrically connected to the power source, wherein the retainer is adapted to removably retain the welding member to be welded to the weld surface; and
a weld actuator adapted to lower the welding member to contact the conduction member, wherein the welding member is adapted to be welded onto the weld surface when the welding member contacts the conduction member.

2. The welding system of claim 1, wherein the weld surface comprises a battery terminal.

3. The welding system of claim 2, wherein the welding member comprises a stud.

4. The welding system of claim 1, wherein the conduction member comprises a washer.

5. The welding system of claim 1, wherein the clamp comprises an anode connection and the retainer comprises a cathode connection.

6. The welding system of claim 1, wherein the retainer comprises a collet.

7. The welding system of claim 1, further comprising a clamp actuator to raise or lower the clamp with respect to the object.

8. The welding system of claim 7, further comprising a housing positioned over the weld surface.

9. The welding system of claim 8, wherein the clamp actuator and the weld actuator are each connected to the housing.

10. The welding system of claim 1, wherein the clamp comprises a rectangular plate.

11. The welding system of claim 10, wherein the clamp comprises an opening, wherein the welding member is adapted to be driven through the opening by the weld actuator.

12. The welding system of claim 11, wherein the opening comprises a depressed opening having sloped sidewalls.

13. A welding system, comprising:
a housing adapted to be positioned over a weld surface;
a conduction member adapted to be positioned on the weld surface;
a welding member adapted to be welded to the weld surface;
a power source for providing an electrical current;
a clamp adapted to transfer the electrical current from the power source to the conduction member, wherein the clamp is electrically connected to the power source;
a retainer adapted to transfer electrical current from the power source to the welding member, wherein the retainer is adapted to removably retain the welding member to be welded to the battery;
a weld actuator connected to the housing, wherein the weld actuator is adapted to lower the welding member to contact the conduction member, wherein the welding member is adapted to be welded onto the weld surface when the welding member contacts the conduction member; and
a clamp actuator connected to the housing, wherein the clamp actuator is adapted to raise and lower the clamp, wherein the clamp actuator is adapted to lower the clamp to retain the conduction member against the weld surface.

14. The welding system of claim 13, wherein the clamp comprises an opening, wherein the weld actuator is adapted to lower the welding member through the opening to contact the conduction member.

15. The welding system of claim 13, wherein the conduction member comprises a washer.

16. The welding system of claim 13, wherein the housing comprises a base, wherein the weld surface is removably connected to the base.

17. The welding system of claim 16, wherein the housing comprises a support extending above the object, wherein the clamp actuator and the weld actuator are each connected to the support.

18. The welding system of claim 13, wherein the weld surface comprises a battery strap.

19. A method of discharge welding, comprising the steps of:
electrically connecting a clamp to a power source;
electrically connecting a retainer to the power source;
securing a conduction member against a weld surface with the clamp;
removably connecting a welding member to the retainer;
adjusting the welding member such that the welding member contacts the conduction member; and
activating the power source to direct an electrical current through the retainer, the welding member, the clamp, and the conduction member such that the welding member is welded to the weld surface by an electrical discharge.

20. The method of claim 19, wherein the weld surface comprises a battery terminal and the welding member comprises a stud.
